(19) United States
(12) Patent Application Publication
(10) Pub. No.: US 2023/0073752 A1
(43) Pub. Date: Mar. 9, 2023

(54) ELECTRONIC DEVICE, WIRELESS COMMUNICATION METHOD, AND COMPUTER-READABLE STORAGE MEDIUM

(71) Applicant: Sony Group Corporation, Tokyo (JP)

(72) Inventors: Youping ZHAO, Beijing (CN); Jiaqi GUO, Beijing (CN); Chen SUN, Beijing (CN); Zhong TIAN, Beijing (CN)

(73) Assignee: Sony Group Corporation, Tokyo (JP)

(21) Appl. No.: 17/797,117

(22) PCT Filed: Mar. 10, 2021
(86) PCT No.: PCT/CN2021/079848

§ 371 Date: Aug. 3, 2022

(30) Foreign Application Priority Data
Mar. 17, 2020 (CN) 202010186688.2

(51) Int. Cl. H04W 72/08; H04W 16/14

(52) U.S. Cl. CPC H04W 72/082; H04W 16/14; H04W 52/367

(57) ABSTRACT

An electronic device includes a processing circuit configured to: with regard to a primary user and at least one secondary user, determine a primary user protection area that surrounds the primary user, wherein the primary user protection area refers to an area where the at least one secondary user causes interference with the primary user; determine a buffer area that surrounds the primary user protection area; and monitor the location of the at least one secondary user, and when the at least one secondary user enters the buffer area, adjust the configuration of the at least one secondary user and/or the configuration of the primary user so as to suppress the interference, caused by the at least one secondary user, with the primary user. By using this approach, interference suppression involving a primary user and a secondary user can be optimized to ensure superior system performance of a primary system.

This application claims the priority to Chinese Patent Application No. 202010186688.2 titled “ELECTRONIC DEVICE, WIRELESS COMMUNICATION METHOD, AND COMPUTER-READABLE STORAGE MEDIUM”, filed on Mar. 17, 2020 with the China National Intellectual Property Administration, which is incorporated herein by reference in its entirety.

### FIELD

Embodiments of the present disclosure generally relate to the field of wireless communications, and in particular to an electronic device, a method for wireless communications, and a computer readable storage medium.

### BACKGROUND

With the evolution of systems for wireless communications, users have increasingly high demands for high quality, high-speed and new services. Operators and device manufacturers have to continually improve the system to meet user demands. Therefore, a large number of spectrum resources are required. However, limited spectrum resources have been allocated to fixed operators and services, and a new available spectrum is scarce and expensive. In this case, a concept of dynamic spectrum utilization is proposed, that is, spectrum resources which have been allocated to certain services but are not fully utilized are utilized dynamically.

A primary system may be a system that has access to a spectrum. A user in the primary system may be referred to as a primary user (PU). A secondary system may be a system that has no access to the spectrum and properly accesses the spectrum only when the primary system does not access the spectrum. A user in the secondary system may be referred to as a secondary user (SU). In addition, both the primary system and the secondary system may have access to a spectrum, but have different priorities in accessing the spectrum. The secondary user is ensured to cause no harmful interference to the primary user when accessing spectrum resources. That is, for the primary user, the interference caused by the secondary user must be tolerable.

In a system where the primary user and the secondary user coexist, when the secondary user is to cause harmful interference to the primary user, a spectrum management device may perform interference suppression to reduce or avoid the harmful interference caused by the secondary user to the primary user. However, it takes a certain amount of time for the spectrum management device to perform the interference suppression. Therefore, before the interference is successfully suppressed, the secondary user has caused harmful interference to the primary user for a period of time, which degrades the system performance of the primary user.

Therefore, it is desired to propose a technical solution to optimize the interference suppression in a system where the primary user and the secondary user coexist, so as to better ensure the system performance of the primary system.

### SUMMARY

This part provides a general summary of the present disclosure, rather than a comprehensive disclosure of its full scope or all of its features.

The object of the present disclosure is to provide an electronic device, a method for wireless communications and a computer-readable storage medium, to optimize the interference suppression in a system where a primary user and a secondary user coexist, so as to better ensure the system performance of the primary system.

According to an aspect of the present disclosure, an electronic device is provided. The electronic device includes processing circuitry. The processing circuitry is configured to: determine, for a primary user and at least one secondary user, a primary user protection area surrounding the primary user, where the primary user protection area represents an area where the at least one secondary user causes interference to the primary user; determine a buffer area surrounding the primary user protection area; and monitor a position of the at least one secondary user, and when the at least one secondary user enters the buffer area, adjust a configuration of the at least one secondary user and/or a configuration of the primary user to suppress the interference caused by the at least one secondary user to the primary user.

According to another aspect of the present disclosure, a method for wireless communications is provided. The method includes: determining, for a primary user and at least one secondary user, a primary user protection area surrounding the primary user, where the primary user protection area represents an area where the at least one secondary user causes interference to the primary user; determining a buffer area surrounding the primary user protection area; and monitoring a position of the at least one secondary user, and when the at least one secondary user enters the buffer area, adjusting a configuration of the at least one secondary user and/or a configuration of the primary user to suppress the interference caused by the at least one secondary user to the primary user.

According to another aspect of the present disclosure, a computer readable storage medium is provided. The computer readable storage medium includes executable computer instructions that, when executed by a computer, cause the computer to perform the method for wireless communications according to the present disclosure.

With the electronic device, the method for wireless communications, and the computer readable storage medium according to the present disclosure, a buffer area is provided around the protection area in which a secondary user causes interference to the primary user. The interference suppression starts when the secondary user enters the buffer area. In this way, the interference suppression has been performed already before the secondary user enters the protection area, and therefore the secondary user causes no harmful interference to the primary user, thereby ensuring the system performance of the primary user.

In the description herein, a further range of applicability becomes apparent. The description and specific examples in the summary are for purposes of illustration only, rather than intended to limit the scope of the present disclosure.

### BRIEF DESCRIPTION OF THE DRAWINGS

The drawings herein are only for illustrating the selected embodiments rather than all possible implementations, and are not intended to limit the scope of the present disclosure. In the drawings:

FIG. 1 is a schematic diagram showing an application scenario of the present disclosure;

FIG. 2 is a block diagram showing a configuration example of an electronic device according to an embodiment of the present disclosure;

FIG. 3 is an exemplary diagram showing a protection area and a buffer area according to an embodiment of the present disclosure;

FIG. 4 is a flowchart showing adjustment of a configuration of a primary user and/or a configuration of a secondary user according to an embodiment of the present disclosure;

FIG. 5 is a flowchart showing signaling for interference suppression according to an embodiment of the present disclosure;

FIG. 6 is a schematic diagram showing that a protection area of a primary user overlaps a protection area of another primary user according to an embodiment of the present disclosure;

FIG. 7 is a schematic diagram showing that a protection area of a primary user overlaps a protection area of another primary user according to an embodiment of the present disclosure;

FIG. 8 is a flowchart showing a method for wireless communications performed by the electronic device according to an embodiment of the present disclosure;

FIG. 9 is a schematic diagram showing a simulation scenario according to an embodiment of the present disclosure;

FIG. 10 is a simulation diagram showing that the number of interruptions in a link for the secondary user varies with the number of the secondary user in a case of one primary user according to an embodiment of the present disclosure;

FIG. 11 is a simulation diagram showing that the number of interruptions in the link for the secondary user varies with the number of the secondary user in a case of multiple primary users according to an embodiment of the present disclosure;

FIG. 12 is a simulation diagram showing that the number of interruptions in the link for the secondary user varies with the number of the secondary user in a case that different kinds of antennas are utilized by the primary user according to an embodiment of the present disclosure;

FIG. 13 is a simulation diagram showing that the probability of interruption in a network of the secondary system varies with the number of the secondary user according to an embodiment of the present disclosure;

FIG. 14 is a simulation diagram showing that system overhead varies with a length of time in flight according to an embodiment of the present disclosure;

FIG. 15 is a block diagram showing an example of a server capable of implementing the electronic device according to the present disclosure;

FIG. 16 is a block diagram showing an example of a schematic configuration of a smartphone; and

FIG. 17 is a block diagram showing an example of a schematic configuration of a car navigation device.

Although various modifications and alternations are easily made to the present disclosure, the specific embodiments of the present disclosure are shown in the drawings by examples, and are described in detail herein. It should be understood that description for the specific embodiments is not intended to limit the present disclosure into the disclosed form. Instead, the present disclosure aims to cover all modifications, equivalents and alternations within the spirit and scope of the present disclosure. It is noted that throughout the drawings, corresponding reference numerals indicate corresponding parts.

### DETAILED DESCRIPTION OF EMBODIMENTS

Examples of the present disclosure are fully disclosed with reference to the drawings. The following description is merely illustrative and is not intended to limit the present disclosure and applications or usage thereof.

Illustrative embodiments are provided, so that the present disclosure becomes thorough and the scope thereof is fully conveyed to those skilled in the art. Examples of specific components, apparatus, methods and other specific details are set forth to provide a thorough understanding of embodiments of the present disclosure. It is apparent for those skilled in the art that, the illustrative embodiments may be implemented in various ways without theses specific details, which should not be constructed limiting the scope of the present disclosure. In some illustrative embodiments, well-known processes, structures and technologies are not described in detail.

Description is made in the following order

1. Description of a scenario
2. Configuration example of electronic device
3. Method embodiments
4. Simulation example

### 5. Application Example

### 1. Description of a Scenario

FIG. 1 is a schematic diagram showing an application scenario according to the present disclosure. As shown in FIG. 1, a wireless communication system includes multiple primary users, and multiple secondary users including a secondary user 1, a secondary user 2, a secondary user 3, a secondary user 4, and a secondary user 5. Here, the primary user is a millimeter-wave backhaul device. The secondary user may be a drone device, a mobile phone, a vehicle-mounted terminal or the like. It should be noted that although FIG. 1 shows the above examples of the primary user and secondary user, the examples of the primary user and secondary user are not limited thereto, and the present disclosure is applicable to all wireless communication systems including a primary system and a secondary system.

In such a system, it is ensured to cause no harmful interference to the primary user by the secondary user accessing spectrum resources. That is, for the primary user, the interference caused by the secondary user must be tolerable.

In view of such a scenario, electronic device in a wireless communication system, a method for wireless communications performed by the electronic device in the wireless communication system, and a computer-readable storage medium are provided according to the present disclosure, to optimize the interference suppression in a system where a primary user and a secondary user coexist, so as to better ensure the system performance of the primary system.

A wireless communication system according to the present disclosure may include a primary system and a secondary system, that is, include one or more primary users and one or more secondary users. The primary user according to the present disclosure is a user in the primary system, and may be a network-side device or user equipment, for example, a millimeter wave backhaul device that is an electronic device that performs a backhaul operation using a millimeter wave. The secondary user according to the present disclosure is a user in the secondary system, and may be a network-side device or user equipment, for example, a drone device on which a network-side device or user equipment is arranged.

In addition, the wireless communication system according to the present disclosure may further include a spectrum management device for managing spectrum utilization of the secondary user, for example, a CxM (Coexistence Manager). Optionally, the wireless communication system may further include a spectrum management database separate from or integrated with the spectrum management device.

The network-side device according to the present disclosure may be a base station device, for example, an eNB, or a gNB (which is a base station in the fifth-generation communication system).

The user equipment according to the present disclosure may be a mobile terminal (such as a smartphone, a tablet personal computer (PC), a notebook PC, a portable game terminal, a portable/dongle mobile router and a digital camera) or a vehicle-mounted terminal (such as a car navigation device). The user equipment may also be implemented as a terminal performing machine to machine (M2M) communication (or a machine-type communication (MTC) terminal). In addition, the user equipment may be a wireless communication module (such as an integrated circuit module including a single wafer) installed on each of the terminals described above.

### 2. Configuration Example of Electronic Device

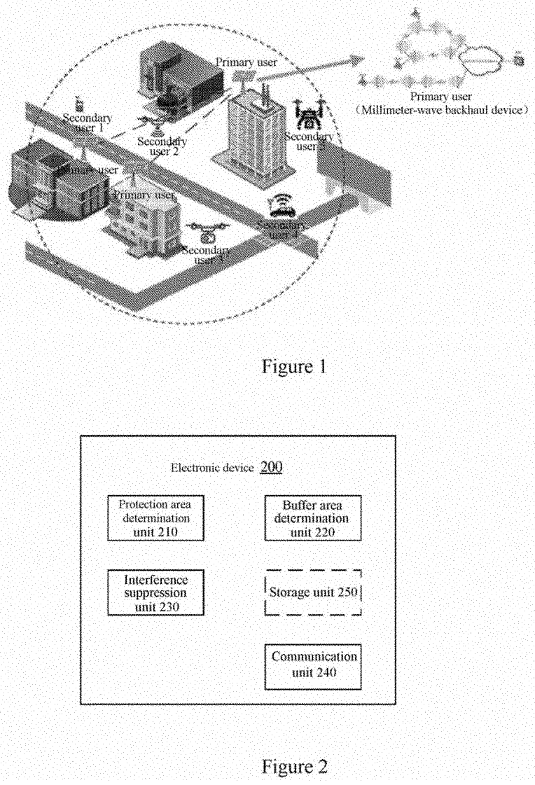

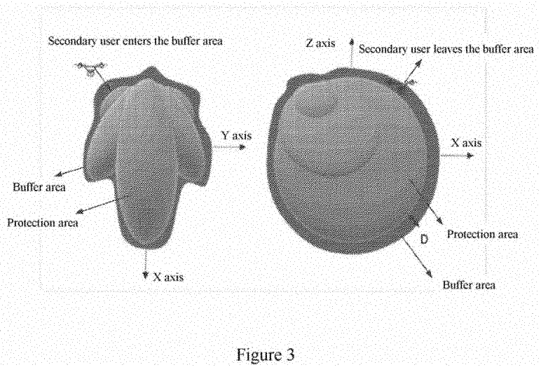

FIG. 2 is a block diagram showing a configuration example of an electronic device 200 according to an embodiment of the present disclosure. The electronic device 200 here may serve as a spectrum management device, for example, a CxM.

As shown in FIG. 2, the electronic device 200 may include a protection area determination unit 210, a buffer area determination unit 220, an interference suppression unit 230 and a communication unit 240.

Here, each unit of the electronic device 200 may be included in processing circuitry. It should be noted that, the electronic device 200 may include one or more processing circuitry. Further, the processing circuitry may include various discrete functional units for performing various functions and/or operations. It should be noted that these functional units may be physical entities or logical entities, and units with different names may be implemented by the same physical entity.

According to an embodiment of the present disclosure, the protection area determination unit 210 may determine, for a primary user and at least one secondary user, a primary user protection area (hereinafter referred to as a protection area) surrounding the primary user. Here, the secondary user, when being in the protection area, causes interference to the primary user. In the present disclosure, causing interference to the primary user refers to causing harmful interference to the primary user, and the harmful interference refers to the interference that the primary user cannot tolerate. That is, the interference caused by the secondary user to the primary user always exists. In a case that interference caused by the secondary user to the primary user is tolerable, the secondary user is allowed to utilize the spectrum resources normally. In a case that interference caused by the secondary user to the primary user is intolerable and thus the primary user fails to operate normally, an interference suppression strategy is implemented to suppress the interference. Such interference that is intolerable for the primary user is called harmful interference.

According to an embodiment of the present disclosure, the buffer area determination unit 220 may determine a buffer area surrounding the protection area.

According to an embodiment of the present disclosure, the electronic device 200 may monitor a position of the at least one secondary user. When the secondary user enters the buffer area, the interference suppression unit 230 may adjust a configuration of the secondary user and/or a configuration of the primary user to suppress the interference caused by the secondary user to the primary user.

According to an embodiment of the present disclosure, the electronic device 200 may interact with the primary user and/or the secondary user via the communication unit 240 to adjust the configuration of the secondary user and/or the configuration of the primary user.

As described above, with the electronic device 200 according to the embodiment of the present disclosure, the buffer area is arranged around the protection area in which harmful interference is caused to the primary user. When the secondary user enters the buffer area, the electronic device 200 starts the interference suppression. In this way, the interference suppression has been performed already before the secondary user enters the protection area, and thus no harmful interference is caused to the primary user, thereby ensuring the system performance of the primary user.

According to an embodiment of the present disclosure, there may be one or more secondary users entering the buffer area, so that the primary user protection area may target one or more secondary users. The arrangement of the protection area and the buffer area and the implementation of the interference suppression are described below by taking one secondary user as an example. The embodiment of the present disclosure is also applicable to the case where multiple secondary users enter the buffer area.

According to an embodiment of the present disclosure, the protection area establishes a boundary of the harmful interference caused to the primary user. That is, the secondary user inside the protection area may cause harmful interference to the primary user, and the secondary user outside the protection area cause no harmful interference to the primary user.

According to an embodiment of the present disclosure, the protection area may be two-dimensional or three-dimensional. In a case that the protection area is two-dimensional, the protection area is a two-dimensional area surrounding the primary user. For example, the primary user and the secondary user both are arranged on the ground, that is, in a case that the primary user and secondary user each have no altitude information, the protection area may be the two-dimension area surrounding the primary user on the ground. In a case that the protection area is three-dimensional, the protection area is a three-dimensional area surrounding the primary user in space.

According to an embodiment of the present disclosure, the protection area determination unit 210 may determine the protection area based on an antenna configuration of the primary user, an antenna configuration of the secondary user, and a threshold of interference that is tolerable for the primary user.

Specifically, the protection area determination unit 210 may determine a maximum transmission power of the secondary user allowed at each position around the primary user based on the antenna configuration of the primary user, the antenna configuration of the secondary user and the threshold of the interference that is tolerable for the primary user; and then determine the protection area based on a transmission power of the secondary user and the maximum transmission powers of the secondary user allowed at all the positions around the primary user.

According to an embodiment of the present disclosure, since the two-dimensional space and the three-dimensional space are continuous, the protection area determination unit 210 may discretize the space, to determine the maximum transmission power of the secondary user allowed at each discrete position. For example, a square of 1 square meter (or a cube of 1 cubic meter) may be determined as a calculation unit, and a center position of each calculation unit may be selected as the discrete position for calculation.

According to an embodiment of the present disclosure, the protection area determination unit 210 may determine a channel gain from a transmitting antenna of the secondary user to a receiving antenna of the primary user based on the antenna configuration of the primary user and the antenna configuration of the secondary user. Here, in a case that the primary user is provided with multiple receiving antennas, the protection area determination unit 210 may calculate, for each of the multiple receiving antennas of the primary user, a channel gain from the transmitting antenna of the secondary user to the receiving antenna, and then add up all the channel gains to obtain a total channel gain from the transmitting antenna of the secondary user to the receiving antenna of the primary user. Further, the protection area determination unit 210 may determine a maximum transmission power of the secondary user allowed at a discrete position based on a distance from the discrete position to the primary user, the channel gain from the transmitting antenna of the secondary user to the receiving antenna of the primary user, and the threshold of interference that is tolerable for the primary user.

For example, the protection area determination unit 210 may calculate a maximum transmission power of the secondary user allowed at a position from the following expression:

$${p}_{su \_ max} = \frac{{I}_{th}}{{( \frac{4 π d}{λ} )}^{- n} {\sum }_{i = 1}^{M} \vert {h}_{i} \vert}$$

P_{su_max} represents the maximum transmission power of the secondary user allowed at a position, d represents a distance from the position to the primary user, represents a wavelength of an operating frequency of the primary user, n represents a free space radio wave propagation loss factor, hᵢ represents a channel gain from the transmitting antenna of the secondary user to an i-th (i is from 1 to M) receiving antenna of the primary user, and M represents the total number of antennas of the primary user.

Iₜₕ represents a threshold of interference that is tolerable for the primary user. According to the embodiment of the present disclosure, the protection area determination unit 210 may determine the threshold of interference that is tolerable for the primary user based on a threshold of a signal to interference plus noise ratio (SINR) of the primary user, a power of a received signal of the primary user and noise of a receiver of the primary user. Here, the electronic device 200 may calculate the threshold of the SINR of the primary user based on the interference protection requirement of the primary user.

For example, Iₜₕ may be calculated from the following formula:

$${I}_{th} = \frac{{p}_{pu}}{{γ}_{0}} - {N}_{0}$$

Pₚᵤ represents a power of a received signal of the primary user, γ₀ represents the threshold of the SINR of the primary user, and N₀ represents the noise of the receiver of the primary user.

According to an embodiment of the present disclosure, after calculating the maximum transmission power of the secondary user allowed at each position around the primary user, the protection area determination unit 210 may determine, as the protection area, an area surrounded by positions at which the maximum transmission power of the secondary user allowed is equal to the transmission power of the secondary user. That is, in a case that the transmission power of the secondary user is denoted as p_{su_0}, the protection area determination unit 210 determines a line formed by points where p_{su_max}=p_{su_0} as a boundary of the protection area. That is, an area including the points where p_{su_max}≤p_{su_0} is the protection area.

Here, in a case that the protection area is a two-dimensional area, the protection area determining unit 210 may determine the maximum transmission power of the secondary user allowed at each position in a two-dimensional space around the primary user, and then determine, as the protection area, an area in the two-dimensional space formed by positions where the maximum transmission power of the secondary user allowed is equal to the transmission power of the secondary user. In a case that the protection area is a three-dimensional area, the protection area determination unit 210 may determine the maximum transmission power of the secondary users allowed at each position in a three-dimensional space around the primary user, and then determine, as the protection area, an area in the three-dimensional space formed by positions where the maximum transmission power of the secondary user allowed is equal to the transmission power of the secondary user.

As described above, according to an embodiment of the present disclosure, the protection area surrounding the primary user may be set as a three-dimensional area since that the secondary user such as a drone is at a certain altitude and the traditional two-dimensional protection area no longer satisfies the requirement for protecting the performance of a primary system. After the protection area is set as a three-dimensional area, the secondary user at a certain altitude may be effectively prevented from causing harmful interference to the primary user.

As described above, according to the embodiment of the present disclosure, the protection area may be determined according to the maximum transmission power of the secondary user allowed at each positions in space, so that the protection area is determined more accurately so as to ensure that the secondary user inside the protection area causes harmful interference to the primary user and that the secondary user outside the protection area does not cause harmful interference to the primary user.

According to an embodiment of the present disclosure, the buffer area determination unit 220 may determine, as a buffer area, an area surrounding the protection area determined by the protection area determination unit 210, having the same shape as the protection area and being surrounded by a boundary at a predetermined distance from the boundary of the protection area.

According to an embodiment of the present disclosure, the buffer area has exactly the same shape as the protection area and is around the protection area. That is, in a case that the protection area is a two-dimensional area, the buffer area is a two-dimensional area, and in a case that the protection area is a three-dimensional area, the buffer area is a three-dimensional area. Further, the distance between the boundary of the buffer area and the boundary of the protection area has a predetermined value D. That is, for each point on the boundary of the protection area, another point with a distance D from the point in the normal direction may be found, and the buffer area determination unit 220 may determines a line formed by these “another points” as the boundary of the buffer area. For example, a buffer area corresponding to a spherical protection area with a radius of r is a spherical area concentric with the protection area and with a radius of r+D. For another example, a buffer area corresponding to a cube protection area with a side length of x is a cube area concentric with the protection area and with a side length of x+2D.

FIG. 3 is an example diagram showing a protection area and a buffer area according to an embodiment of the present disclosure. FIG. 3 shows the protection area and the buffer area viewed at an angle on the left and shows the protection area and the buffer area viewed at another angle on the right. As shown in FIG. 3, an inner light-colored three-dimensional area is the protection area, and an outer dark three-dimensional area is the buffer area. The buffer area has exactly the same shape as the protection area, and a distance between a boundary of the buffer area and a boundary of the protection area is D in the normal direction.

According to an embodiment of the present disclosure, the buffer area determination unit 220 may determine the predetermined distance D based on at least one of the following parameters: a speed of the secondary user, a speed at which the secondary user processes data, a speed at which the primary user processes data, and a speed at which the electronic device 200 processes data.

According to an embodiment of the present disclosure, a large speed of the secondary user corresponding to a long distance D determined by the buffer area determination unit 220. That is, when the speed of the secondary user is large, the buffer area determination unit 220 may set the buffer area to be larger, so that there is sufficient time to perform the interference suppression before the secondary user enters the protection area.

According to an embodiment of the present disclosure, in a case that the speed at which the secondary user processes data is slow, the speed at which the primary user processes data is slow, and/or the speed at which the electronic device 200 processes data is slow, the buffer area determination unit 220 may set the predetermined distance D to be large. Here, since the interference suppression process depends on the participation of the electronic device 200, the primary user and the secondary user, the buffer area determination unit 220 sets the buffer area to be large in a case that the speed at which data is processed is slow, so that there is sufficient time to perform the interference suppression before the secondary user enters the protection area.

According to an embodiment of the present disclosure, the buffer area determination unit 220 may determine the predetermined distance D by multiplying the speed of the secondary user by the total period of time spent in processing data. For example, D is determined from the following expression:

D=v×t₁

v represents the speed of the secondary user, specifically, v represents the speed of the secondary user in a case that the secondary user moves at a constant speed and v represents a maximum speed of the secondary user during the movement in a case that the secondary user moves at a variable speed. t₁ is the total period of time spent in processing data, and is a sum of a period of time spent by the primary user in processing data, a period of time spent by the secondary user in processing data, and a period of time spent by the electronic device 200 in processing data. For example, t₁ is calculated from the following expression:

$${t}_{1} = \frac{}{} + \frac{{D}_{u}}{} + \frac{{D}_{m}}{{μ}_{m}}$$

[symbol] represents the amount of data processed by the primary user. [symbol] represents the amount of data processed by the secondary user. Dₘ represents the amount of data processed by the electronic device 200. [symbol] , [symbol] , μₘ represent the speed at which the secondary user processes data, the speed at which the primary user processes data, and the speed at which the electronic device 200 processes data, respectively.

According to an embodiment of the present disclosure, the amount of data processed by the primary user may be determined based on the maximum data volume that may be processed by the primary user in the interference suppression, for example, the amount of data processing generated in adjustment of the configuration of the primary user until the configuration of the primary user is not allowed to be adjusted (for example, when the antenna configuration of the primary user is not allowed to be adjusted or the threshold number of adjustments for the primary user is reached). Similarly, the amount of data processed by the secondary user may be determined based on the maximum data volume that may be processed by the secondary user in the interference suppression, for example, the amount of data processing generated in adjustment of the configuration of the secondary user until the configuration of the secondary user is not allowed to be adjusted (for example, when the transmission power of the secondary user reaches a minimum value or the threshold number of adjustments for the secondary user is reached).

As described above, according to an embodiment of the present disclosure, the period of time spent in processing data may be estimated based on the maximum amount of data processed by the primary user and the maximum amount of data processed by the secondary user, so as to calculate the predetermined distance D. In this way, the calculated predetermined distance D is large enough so that there is sufficient time to perform the interference suppression before the secondary user enters the protection area. In addition, in the calculation of D, it is considered that the secondary user enters the buffer area and the protection area along the normal direction of the protection area and the buffer area, so that the calculated predetermined distance D is further large enough, that is, there is sufficient time to perform the interference suppression before the secondary user reaches the protection area, thereby avoiding the delay resulted from the interference suppression algorithm.

According to an embodiment of the present disclosure, the electronic device 200 may acquire secondary user information from the secondary user. The secondary user information includes but is not limited to a position of the secondary user, a speed of the secondary user, a movement route of the secondary user, antenna configuration information of the secondary user. In addition, the electronic device 200 may acquire primary user information, including but not limited to a position of the primary user and antenna configuration information of the primary user, from a spectrum management database by sending a request to the spectrum management database.

As described above, the electronic device 200 may acquire the primary user information from the spectrum management database. Optionally, historical configuration information about a specific scenario may also be stored in the spectrum management database, and the electronic device 200 may acquire the historical configuration information by interacting with the spectrum management database (which will be described in detail below). It can be seen that in the process of performing the interference suppression, the electronic device 200 may interacts with the spectrum management database.

According to an embodiment of the present disclosure, the buffer area determination unit 220 may further determine the predetermined distance D based on the speed of the secondary user, the speed at which the secondary user processes data, the speed at which the primary user processes data, the speed at which the electronic device 200 processes data, and a period of time during which the electronic device 200 interacts with another device (e.g., the spectrum management database). Specifically, the buffer area determination unit 220 may determine the predetermined distance D by multiplying the speed of the secondary user by the sum of the total period of time spent in processing data and the period of time during which the electronic device 200 interacts with the spectrum management database. For example, D may be determined from the following expression:

D=v×(t₁+t₂)

v and t₁ have been described in detail above. t₂ represents the period of time during which the electronic device 200 interacts with the spectrum management database, including a period of time during which the electronic device 200 sends information to the spectrum management database and a period of time during which the electronic device 200 receives information from the spectrum management database. For example, t₂ may be calculated from the following expression:

t₂=tᵤₚ+t_{down}

tᵤₚ represents the period of time during which the electronic device 200 sends information to the spectrum management database, and t_{down} represents the period of time during which the electronic device 200 receives information from the spectrum management database.

That is, in a case that the electronic device 200 only receives the primary user information from the spectrum management database and stores the historical configuration information in the electronic device 200, tᵤₚ represents a period of time during which the electronic device 200 sends a message for requesting the primary user information to the spectrum management database, and t_{down} represents a period of time during which the electronic device 200 receives the primary user information from a spectrum management device. Optionally, in a case that the electronic device 200 only receives the primary user information from the spectrum management database and stores the historical configuration information in the spectrum management database, tᵤₚ represents a period of time during which the electronic device 200 sends a message for requesting the primary user information to the spectrum management database and a period of time during which the electronic device 200 sends a message for requesting the historical configuration information to the spectrum management database, and t_{down} represents a period of time during which the electronic device 200 receives the primary user information from the spectrum management device and a period of time during which the electronic device 20 receives the historical configuration information from the spectrum management database.

As mentioned above, the buffer area determination unit 220 determines the buffer area based on both the period of time spent in processing data and the period of time spent in interacting with the spectrum management database, so that the calculated predetermined distance D is accurate and sufficient, that is, there is enough time to perform the interference suppression before the secondary user reaches the protection area.

As described above, according to the embodiment of the present disclosure, the protection area determination unit 210 may reasonably determine the protection area, and the buffer area determination unit 220 may determine the buffer area around the protection area. The determined buffer area is sufficient to offset the delay caused by executing the interference suppression algorithm, so that the harmful interference caused by the secondary user is suppressed before the secondary user enters the protection area, thereby better protecting the performance of the primary user.

It should be noted that, the protection area according to the embodiment of the present disclosure is determined based on the antenna configuration of the primary user and the antenna configuration of the secondary user. Therefore, the protection area is specific to a primary user and a secondary user. That is, the determined protection area varies from a combination of a primary user and a secondary user to another. For example, the protection area determined for the primary user A and secondary user B may be different from the protection area determined for the primary user A and secondary user C. Further, since the buffer area is determined based on the protection area, the buffer area is also specific to a primary user and a secondary user.

According to an embodiment of the present disclosure, when the secondary user enters the buffer area, the interference suppression unit 230 starts the interference suppression. Here, the secondary user entering the buffer area means that the secondary user reaches the boundary of the buffer area and moves towards the buffer area. Further, the electronic device 200 may acquire the position of the secondary user in real time to determine that the secondary user is about to enter the buffer area. Optionally, the electronic device 200 may send the information on the buffer area and the protection area to the secondary user, and the secondary user may send notification information to the electronic device 200 when the secondary user is about to enter the buffer area, so that the electronic device 200 determines that the secondary user is about to enter the buffer area based on the notification information from the secondary user indicating that the secondary user is about to enter the buffer area.

As shown in FIG. 2, according to an embodiment of the present disclosure, the electronic device 200 may further include a storage unit 250 for storing historical configuration information corresponding to a historical scenario. That is, the storage unit 250 may store a mapping relationship between the historical scenario and historical configuration information, and each mapping relationship includes a historical scenario and historical configuration information corresponding to the historical scenario.

According to an embodiment of the present disclosure, the historical scenario may include a serial number of the primary user and a serial number of the secondary user. The historical configuration information may include the configuration of the primary user and/or the configuration of the secondary user. That is, the interference suppression has been performed for the primary user and the secondary user previously. The historical configuration information includes the adjusted configuration of the primary user and/or adjusted configuration of the secondary user determined in the process of performing the interference suppression. An example of the above information stored in the storage unit 250 is shown in Table 1.

TABLE 1

| | Serial | | | configuration |
|---|---|---|---|---|
| Serial | number | | configuration | of |
| number of | of primary | Serial number of | of primary | secondary |
| scenario | user | secondary user | user | user |
| 1 | primary | secondary user 1 | antenna | transmission |
| | user 1 | | configuration 1 | power 1 |
| 2 | primary | secondary user 1, | antenna | transmission |
| | user 2 | secondary user 2 | configuration 2 | power1, |
| | | | | transmission |
| | | | | power 2 |
| . . . | . . . | . . . | . . . | . . . |
| N | primary | secondary user N | antenna | transmission |
| | user N | | configuration N | power N |

As shown in Table 1, a historical scenario 1 indicates that a secondary user 1 enters a buffer area around a primary user 1 for a combination of the primary user 1 and the secondary user 1. A result of the interference suppression is that the transmission power of the secondary user 1 is adjusted to a transmission power 1, and the antenna configuration of the primary user 1 is adjusted to an antenna configuration 1. A historical scenario 2 indicates that both a secondary user 1 and a secondary user 2 enter a buffer area around a primary user 2 for a combination of the primary user 2 and the secondary users 1 and 2. A result of the interference suppression is that the transmission power of the secondary user 1 is adjusted to a transmission power 1, the transmission power of the secondary user 2 is adjusted to a transmission power 2, and the antenna configuration of the primary user 2 is adjusted to an antenna configuration 2.

According to an embodiment of the present disclosure, the historical scenario and the historical configuration information may be stored in the electronic device 200, or may be stored in a device, for example, the spectrum management database, separated from the electronic device 200.

According to an embodiment of the present disclosure, when the secondary user enters the buffer area, the interference suppression unit 230 may determine whether the storage unit 250 or the spectrum management database stores the historical configuration information corresponding to a scenario including the primary user and the secondary user.

According to an embodiment of the present disclosure, the electronic device 200 may acquire the serial number of secondary user when acquiring the secondary user information from the secondary user, and acquire the serial number of the primary user when acquiring the primary user information from the spectrum management database, so as to search the storage unit 250 or the spectrum management database based on the serial number of the secondary user and the serial number of the primary user to determine whether there is a historical scenario matching the primary user and the secondary user.

According to an embodiment of the present disclosure, in a case that the historical configuration information corresponding to a current scenario is stored in the storage unit 250 or the spectrum management database, the interference suppression unit 230 may determine the adjusted configuration of the secondary user and/or the adjusted configuration of the primary user based on the historical configuration information.

For example, in a case that the electronic device 200 determines that the serial number of the primary user is 1 and the serial number of the secondary user is 1, the electronic device 200 may determine that the historical scenario 1 matches the current scenario. In this case, the interference suppression unit 230 may directly determine the configuration of the primary user and/or the configuration of the secondary user based on the historical configuration information corresponding to the historical scenario 1. For example, the interference suppression unit 230 may configure the antenna of the primary user based on the antenna configuration 1, and adjust the transmission power of the secondary user based on the transmission power 1.

It should be noted that multiple secondary users may all enter the buffer area. In this case, the electronic device 200 searches the historical scenario based on the serial number of each of the multiple secondary users. It is determined that the historical configuration information corresponding to the current scenario is stored only in a case that all the secondary users in the historical scenario respectively match all the secondary users in the current scenario. For example, in a case that the serial number of the primary user is 2 in the current scenario, and there are two secondary users in the current scenario with the serial numbers of 1 and 2 respectively, the interference suppression unit 230 may determine that the current scenario matches the historical scenario 2.

As described above, according to the embodiment of the present disclosure, the historical configuration information corresponding to the historical scenario may be stored, so that the historical configuration information is directly used to configure the primary user and/or the secondary user in a case that the current scenario matches the historical scenario, without performing the interference suppression, thereby simplifying the interference suppression process and saving time.

According to an embodiment of the present disclosure, in a case that no historical configuration information corresponding to the current scenario is stored, the interference suppression unit 230 may determine the adjusted configuration of the secondary user and/or the adjusted configuration of the primary user based on the threshold of interference that is tolerable for the primary user. That is, in the absence of a matched historical scenario, the interference suppression unit 230 has to perform the interference suppression.

According to an embodiment of the present disclosure, since the SINR threshold of the primary user is associated with the threshold of interference that is tolerable for the primary user, the SINR threshold of the primary user may be used to represent the threshold of interference that is tolerable for the primary user.

According to an embodiment of the present disclosure, the configuration of the secondary user may include the transmission power of the secondary user and/or the operating frequency of the secondary user, and the configuration of the primary user may include the antenna configuration of the primary user. That is, the result of performing the interference suppression may be that at least one of the transmission power of the secondary user, the operating frequency of the secondary user and the antenna configuration of the primary user is adjusted.

According to an embodiment of the present disclosure, the interference suppression unit 230 may preferentially adjust the transmission power of the secondary user. For example, the interference suppression unit 230 may reduce transmission power of the secondary user.

According to an embodiment of the present disclosure, the interference suppression unit 230 may directly adjust the transmission power of the secondary user to a minimum, and then send the adjusted transmission power to the secondary user via the communication unit 240. Next, the interference suppression unit 230 may determine whether the interference suffered by the primary user, after the transmission power of the secondary user is adjusted to the minimum, is tolerable, that is, whether the SINR of the primary user is greater than the SINR threshold.

Optionally, the interference suppression unit 230 may gradually reduce the transmission power of the secondary user until the SINR of the primary user is greater than the SINR threshold or the transmission power of the secondary user is not allowed to be reduced any more or the number of adjustments for the secondary user reaches a threshold. For example, the interference suppression unit 230 may reduce the transmission power of the secondary user by one level, and then send the adjusted transmission power to the secondary user via the communication unit 240. Next, the interference suppression unit 230 determines whether the interference suffered by the primary user, after the transmission power of the secondary user is reduced by one level, is tolerable, that is, whether the SINR of the primary user is greater than the SINR threshold. In a case that the SINR of the primary user is less than or equal to the SINR threshold, the interference suppression unit 230 reduces the transmission power of the secondary user by one level once again and then sends the adjusted transmission power to the secondary user via the communication unit 240, and so on, until the SINR of the primary user is greater than the SINR threshold or the transmission power of the secondary user is not allowed to be reduced or the number of adjustments for the secondary user reaches the threshold.

According to an embodiment of the present disclosure, if the SINR of the primary user is greater than the SINR threshold after the transmission power of the secondary user is adjusted, the interference suppression unit 230 determines that the interference suppression process ends, and the result of performing the interference suppression is that the transmission power of the secondary user is adjusted.

According to an embodiment of the present disclosure, in a case that the transmission power of the secondary user is adjusted to the minimum and the SINR of the primary user is less than or equal to the SINR threshold, the interference suppression unit may adjust the antenna configuration of the primary user.

According to an embodiment of the present disclosure, adjusting the antenna configuration of the primary user includes increasing the number of antenna elements of the primary user, reducing the number of antenna elements of the primary user, and/or adjusting a weight of an antenna element of the primary user. Here, increasing the number of antenna elements of the primary user may include adding an antenna element according to a predetermined rule, for example, adding one antenna element to both the left end and the right end each time. Reducing the number of antenna elements of the primary user may also include removing an antenna element according to a predetermined rule, for example, removing one antenna element at both the left end and the right end each time. Here, the interference suppression unit 230 may determine a strategy for adjusting the antenna of the primary user based on the type and configuration of the antenna of the primary user, so that the SINR of the primary user is possibly greater than the SINR threshold after the antenna of the primary user is adjusted.

According to an embodiment of the present disclosure, the interference suppression unit 230 may gradually adjust the antenna configuration of the primary user. For example, in the case of reducing the number of antenna elements of the primary user, the interference suppression unit 230 may remove one antenna element at both the left end and the right end each time, and then send the adjusted antenna configuration to the primary user via the communication unit 240. Next, the interference suppression unit 230 determines whether the interference suffered by the primary user, after the antenna configuration of the primary user is adjusted, is tolerable, that is, whether the SINR of the primary user is greater than the SINR threshold. In a case that the SINR of the primary user is less than or equal to the SINR threshold after the antenna configuration of the primary user is adjusted, the interference suppression unit 230 removes one antenna element at both the left end and the right end once again and then send the adjusted antenna configuration to the primary user via the communication unit 240, and so on, until the SINR of the primary user is greater than the SINR threshold value or the antenna elements of the primary user is not allowed to be reduced or the number of adjustments for the primary user reaches the threshold.

According to an embodiment of the present disclosure, if the SINR of the primary user is greater than the SINR threshold after the antenna configuration of the primary user is adjusted, the interference suppression unit 230 determines that the interference suppression process ends, and the result of performing the interference suppression process is that the transmission power of the secondary user is adjusted and the antenna configuration of the primary user is adjusted.

According to an embodiment of the present disclosure, in a case that the transmission power of the secondary user is adjusted to the minimum, the antenna configuration of the primary user is not allowed to be adjusted, and the SINR of the primary user is less than or equal to the SINR threshold, the interference suppression unit may adjust the operating frequency of the secondary user. That is, in this case, no matter how the transmission power of the secondary user and the antenna configuration of the primary user are adjusted, the harmful interference caused by the secondary user to the primary user fails to be avoided. Therefore, the operating frequency of the secondary user is adjusted so that the secondary user operates at a frequency different from the primary user to avoid harmful interference to the primary user.

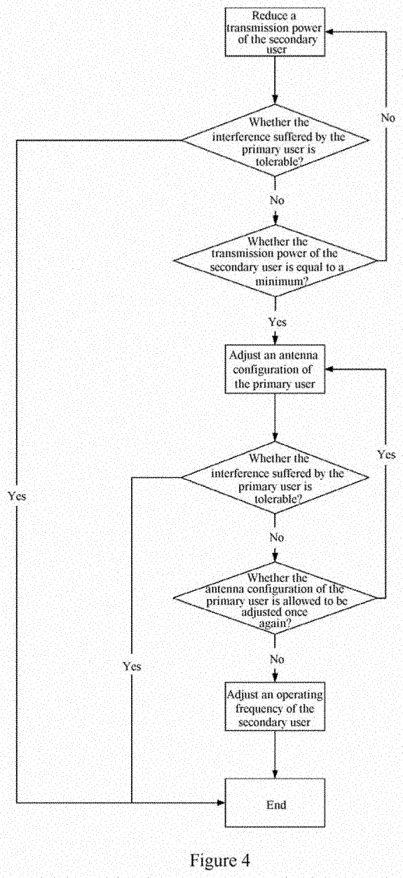

FIG. 4 is a flowchart showing adjustment of the configuration of the primary user and/or the configuration of the secondary user according to an embodiment of the present disclosure. As shown in FIG. 4, the interference suppression unit 230 first reduces the transmission power of the secondary user. After the transmission power of the secondary user is reduced, the interference suppression unit 230 recalculates the SINR of the primary user and determines whether the interference suffered by the primary user is tolerable. In a case that the interference suffered by the primary user is tolerable, the interference suppression process ends. In a case that the interference suffered by the primary user is intolerable, the interference suppression unit 230 determines whether the transmission power of the secondary user is equal to the minimum. In a case that the transmission power of the secondary user is not equal to the minimum, the interference suppression unit 230 reduces the transmission power of the secondary user once again. In a case that the transmission power of the secondary user is already equal to the minimum, the interference suppression unit 230 adjusts the antenna configuration of the primary user. After the antenna configuration of the primary user is adjusted, the interference suppression unit 230 recalculates the SINR of the primary user, and then determines whether the interference suffered by the primary user is tolerable. In a case that interference suffered by the primary user is tolerable, the interference suppression process ends. In a case that the interference suffered by the primary user is intolerable, the interference suppression unit 230 determines whether the antenna configuration of the primary user is allowed to be adjusted once again. If it is determined that the antenna configuration of the primary user is allowed to be adjusted once again, the interference suppression unit 230 adjusts the antenna configuration of the primary user once again. If it is determined that the antenna configuration of the primary user is not allowed to be adjusted once again, the interference suppression unit 230 adjusts the operating frequency of the secondary user. In addition, each of the number of adjustments for the primary user and/or the number of adjustments for the secondary user is provided with a threshold. That is, the end of adjusting the transmission power of the secondary user may be conditional on the number of adjustments for the secondary user reaching its threshold, and the end of adjusting the antenna configuration of the primary user may be conditional on the number of adjustments for the primary user reaching its threshold.

As described above, according to the embodiment of the present disclosure, the interference suppression unit 230 may suppress harmful interference caused by the secondary user to the primary user by adjusting the transmission power of the secondary user, the operating frequency of the secondary user, and/or the antenna configuration of the primary user.

According to an embodiment of the present disclosure, in a case that no historical configuration information corresponding to the current scenario is stored in the storage unit 250 or the spectrum management database, the interference suppression unit 230 may store the adjusted configuration of the secondary user and/or the adjusted configuration of the primary user in the storage unit 250 or the spectrum management database as a piece of historical configuration information. The stored historical scenario includes the serial number of the current primary user and the serial number of the current secondary user. The stored historical configuration information includes the adjusted transmission power of the secondary user, or includes both the adjusted transmission power of the secondary user and the adjusted antenna configuration of the primary user.

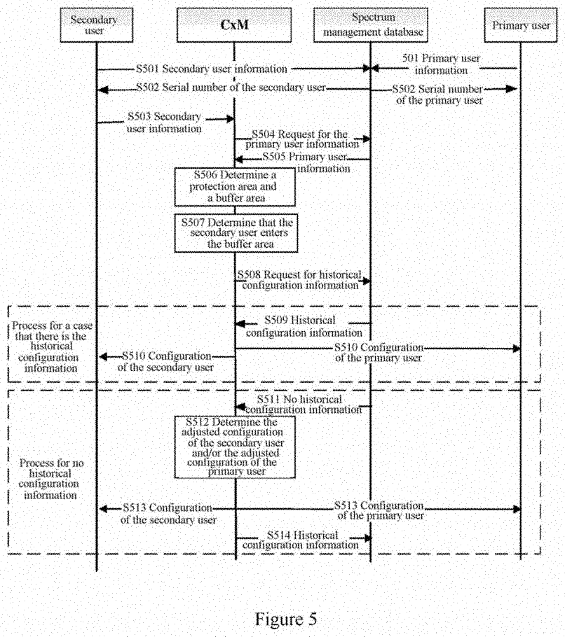

FIG. 5 is a flowchart showing signaling for interference suppression according to an embodiment of the present disclosure. In FIG. 5, a CxM may be implemented by the electronic device 200. In step S501, the secondary user sends the secondary user information to the spectrum management database. The secondary user information includes but is not limited to a position of the secondary user, a speed of the secondary user, a movement route of the secondary user and antenna configuration of the secondary user. Further, the primary user sends the primary user information to the spectrum management database. The primary user information includes but is not limited to a position of the primary user and antenna configuration of the primary user. Next, the spectrum management database sets a serial number for the primary user and a serial number for the secondary user. In step S502, the spectrum management database sends the serial number of the primary user to the primary user, and sends the serial number of the secondary user to the secondary user. Next, in step S503, the CxM acquires the secondary user information, including but not limited to the position of the secondary user, the speed of the secondary user, the movement route of the secondary user, the antenna configuration of the secondary user and the serial number of the secondary user from the secondary user. Next, in step S504, the CxM requests from the spectrum management database the primary user information including but not limited to the position of the primary user, the antenna configuration of the primary user and the number serial of the primary user. Next, in step S505, the spectrum management database sends the primary user information to the CxM. Next, in step S506, the CxM determines a protection area and a buffer area for each possible combination of the primary user and the secondary user. Next, in step S507, the CxM determines that the secondary user enters the buffer area specific to the secondary user and a primary user. Next, in step S508, the CxM requests historical configuration information from the spectrum management database. For example, the CxM sends the serial number of the primary user and the serial number of the secondary user corresponding to a current scenario to the spectrum management database, so as to determine whether there is historical configuration information corresponding to the current scenario. If there is the historical configuration information corresponding to the current scenario, the spectrum management database feeds the historical configuration information back to the CxM in step S509. Next, in step S510, the CxM sends configuration of the secondary user in the historical configuration information to the secondary user so as to adjust the configuration of the secondary user, and/or sends configuration of the primary user in the historical configuration information to the primary user so as to adjust the configuration of the primary user. If there is no historical configuration information corresponding to the current scenario, the spectrum management database sends a message indicating that there is no corresponding historical configuration information to the CxM in step S511. Next, in step S512, the CxM determines the adjusted configuration of the secondary user and/or the adjusted configuration of the primary user based on the aforementioned interference suppression process. Next, in step S513, the CxM sends the configuration of the secondary user to the secondary user so as to adjust the configuration of the secondary user, and/or sends the configuration of the primary user to the primary user so as to adjust the configuration of the primary user. Next, in step S514, the CxM sends the adjusted configuration of the primary user and/or the adjusted configuration of the secondary user, as well as the current scenario to the spectrum management database, as a new piece of historical configuration information. As described above, according to the embodiment of the present disclosure, the CxM performs the interference suppression, thereby suppressing harmful interference caused by the secondary user to the primary user.

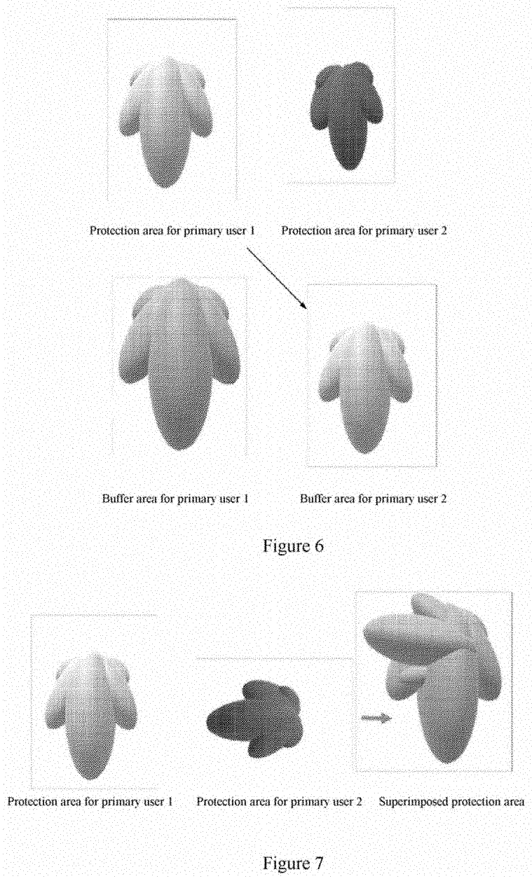

According to an embodiment of the present disclosure, there is a case in which a protection area of a primary user overlaps a protection area of another primary user. FIG. 6 is a schematic diagram showing the case in which a protection area of a primary user overlaps a protection area of another primary user according to an embodiment of the present disclosure. As shown in FIG. 6, for the same secondary user, the protection area of the primary user 1 is exactly in the same shape as the protection area of the primary user 2, and the protection area of the primary user 1 completely covers the protection area of the primary user 2. In this case, the protection area of the primary user 1 may serve as the buffer area of the primary user 2, and only the buffer area of the primary user 1 is to be recalculated.

FIG. 7 is a schematic diagram showing the case in which a protection area of a primary user overlaps a protection area of another primary user according to another embodiment of the present disclosure. For the same secondary user, the protection area of the primary user 1 overlaps the protection area of the primary user 2. In this case, a new protection area may be determined by directly superimposing the protection area of the primary user 1 and the protection area of the primary user 2 in space. The electronic device 200 may regard the primary user 1 and the primary user 2 as a whole, that is, determine the buffer area based on the superimposed protection area, and regard the two primary users as a whole to perform the interference suppression. For example, after the transmission power of the secondary user is reduced, it is determined whether the interference suffered by the primary user 1 is tolerable and whether the interference suffered by the primary user 2 is tolerable.

It can be seen that a buffer area is arranged around the protection area where harmful interference is caused to the primary user according to the embodiment of the present disclosure. When the secondary user enters the buffer area, the electronic device 200 starts the interference suppression process. In this way, the interference suppression has been performed already when the secondary user enters the protection area, and thus no harmful interference is caused to the primary user, thereby ensuring the system performance of the primary user. Furthermore, not only the period of time spent in processing data and the speed of the secondary user but also the period of time spent in interacting with the spectrum management database are considered in determination of the size of the buffer area, so that the calculated predetermined distance D is accurate and sufficient, that is, there is enough time to perform the interference suppression before the secondary user reaches the protection area. In addition, the interference suppression may be performed by adjusting the transmission power of the secondary user, the operating frequency of the secondary user, and/or the antenna configuration of the primary user, thereby effectively suppressing harmful interference caused by the secondary user to the primary user. In summary, according to the embodiment of the present disclosure, the interference suppression in the system where a primary user and a secondary user coexist can be optimized, thereby better ensuring the system performance of the primary system.

### 3. Method Embodiments

In the following, a method for wireless communications performed by the electronic device 200 in a wireless communication system according to an embodiment of the present disclosure is described in detail.

FIG. 8 is a flowchart showing the method for wireless communications performed by the electronic device 200 in a wireless communication system according to an embodiment of the present disclosure.

As shown in FIG. 8, in step S810, a primary user protection area surrounding a primary user is determined for the primary user and at least one secondary user. The primary user protection area represents an area where the at least one secondary user causes interfere to the primary user.

Next, in step S820, a buffer area around the protection area is determined.

Next, in step S830, a position of the at least one secondary user is monitored, and when the at least one secondary user enters the buffer area, at least one of configuration of the at least one secondary user and configuration of the primary user is adjusted so as to suppress the harmful interference caused by the at least one secondary user to the primary user.

Preferably, determining the protection area includes: determining the protection area based on an antenna configuration of the primary user, an antenna configuration of the at least one secondary user, and a threshold of interference that is tolerable for the primary user.

Preferably, determining the protection area includes: determining a maximum transmission power of the at least one secondary user allowed at each position around the primary user based on the antenna configuration of the primary user, the antenna configuration of at least one secondary user and the threshold of interference that is tolerable for the primary user; and determining the primary user protection area based on a transmission power of the at least one secondary user and the maximum transmission power of the at least one secondary user allowed at all the positions around the primary user.

Preferably, the primary user protection area and the buffer area are both two-dimensional areas. Alternatively, the primary user protection area and the buffer area are both three-dimensional areas.

Preferably, the determining a buffer area includes: determining, as the buffer area, an area surrounding the primary user protection area, having the same shape as the primary user protection area and surrounded by a boundary at a predetermined distance from a boundary of the primary user protection area.

Preferably, the determining a buffer area includes: determining the predetermined distance based on at least one of the following parameters: a speed of the at least one secondary user, a speed at which the at least one secondary user processes data, a speed at which the primary user processes data, and a speed at which the electronic device processes data.

Preferably, the adjusting a configuration of the at least one secondary user and/or a configuration of the primary user includes: determining when the at least one secondary user enters the buffer area, whether historical configuration information corresponding to a scenario including the primary user and the at least one secondary user is stored; and determining the adjusted configuration of the at least one secondary user and/or the adjusted configuration of the primary user based on the historical configuration information in a case that there is stored historical configuration information corresponding to the scenario.

Preferably, the adjusting a configuration of the at least one secondary user and/or a configuration of the primary user includes: determining the adjusted configuration of the at least one secondary user and/or the adjusted configuration of the primary user based on a threshold of interference that is tolerable for the primary user in a case that no historical configuration information corresponding to the scenario is stored.

Preferably, the configuration of the at least one secondary user includes the transmission power of the at least one secondary user and/or an operating frequency of the at least one secondary user, and the configuration of the primary user includes the antenna configuration of the primary user.

Preferably, the adjusting a configuration of the at least one secondary user and/or a configuration of the primary user includes: adjusting the transmission power of the at least one secondary user in a case that no historical configuration information corresponding to the scenario is stored.

Preferably, the adjusting the transmission power of the at least one secondary user includes reducing the transmission power of the at least one secondary user.

Preferably, the adjusting a configuration of the at least one secondary user and/or a configuration of the primary user includes: determining whether the interference suffered by the primary user is tolerable after the transmission power of the at least one secondary user is adjusted; and adjusting the antenna configuration of the primary user in a case the interference suffered by the primary user is intolerable.

Preferably, the adjusting the antenna configuration of the primary user includes increasing the number of antenna elements of the primary user, reducing the number of antenna elements of the primary user, and/or adjusting the weight of an antenna element of the primary user.

Preferably, the adjusting a configuration of at least one secondary user and/or a configuration of the primary user includes: determining whether the interference suffered by the primary user is tolerable after the antenna configuration of the primary user is adjusted; and adjusting the operating frequency of the at least one secondary user in a case that the interference suffered by the primary user is intolerable.

Preferably, the method for wireless communications further includes: storing the adjusted configuration of the at least one secondary user and/or the adjusted configuration of the primary user as historical configuration information corresponding to a scenario including the primary user and the at least one secondary user.

Preferably, the electronic device 200 is a coexistence manager CxM.

According to the embodiment of the present disclosure, the subject performing the above method may be the electronic device 200 according to the embodiment of the present disclosure, and thus all of the embodiments described above with respect to the electronic device 200 are applicable thereto.

### 4. Simulation Example

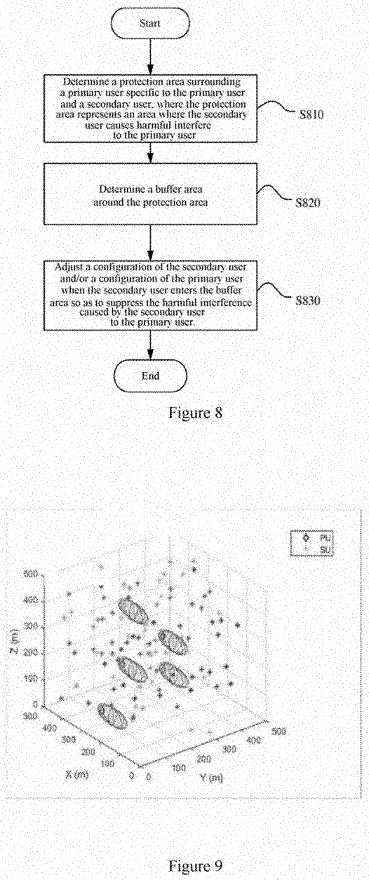

FIG. 9 is a schematic diagram showing a simulation scenario according to an embodiment of the present disclosure. The following table shows the parameters for the simulation scenario.

TABLE 2

| Parameters | Parameter values |
|---|---|
| Central operating frequency | 75 GHz |
| Simulation area | 500 m × 500 m × 500 m |
| Channel bandwidth | 500 MHz |
| Transmission power of primary user | 10 dBm |
| SINR threshold value of primary user | 25 dB |
| Transmission power of secondary user | 10 dBm~20 dBm |
| Minimum spacing of secondary users | 10 m |
| Antenna height of primary user | 20 m~100 m |
| Path loss factor | 2 |
| Antenna elements of primary user | Patch |
| Antenna array type of primary user | ULA (64 ULA-2 ULA) |
| Antenna of secondary user | 0 mni |
| Speed of secondary user | 0~20 m/s |

In this scenario, the primary user is a millimeter-wave backhaul device, and the secondary user is a drone device with a UE arranged thereon. Furthermore, the primary user remains stationary, and the movement of the secondary user follows random walk. As shown in FIG. 9, PU represents the primary user, around which is a buffer area and a protection area, and SU represents the secondary user.

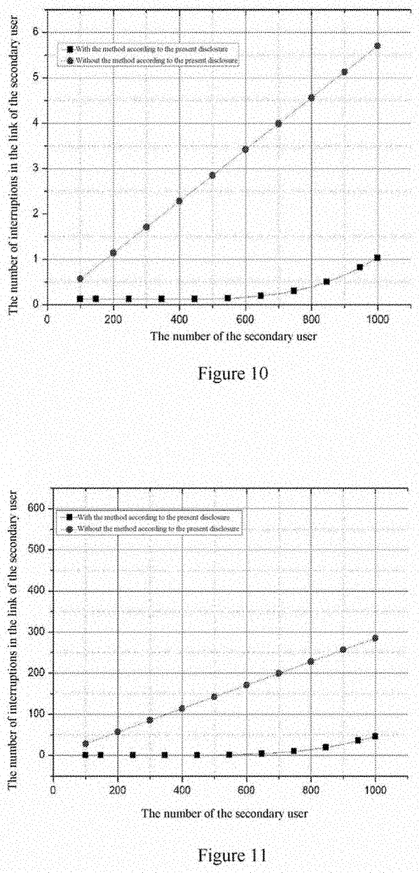

FIG. 10 is a simulation diagram showing that the number of interruptions in a link for the secondary user varies with the number of the secondary user in a case of one primary user according to an embodiment of the present disclosure. In FIG. 10, one primary user is provided, and the number of secondary users is gradually increased from 100 to 1000. As can be seen from FIG. 10, without implementing the embodiment according to the present disclosure, a probability that the secondary user is interrupted increases with the increase in the number of the secondary user, and about 6 out of 1000 secondary users are interrupted. In the embodiment according to the present disclosure, the probability that the secondary user is interrupted is significantly reduced, and only 1 out of 1000 secondary users is interrupted. It can be seen that, according to the embodiment of the present disclosure, the probability that the secondary user is interrupted can be significantly reduced.

FIG. 11 is a simulation diagram showing that the number of interruptions in the link for the secondary user varies with the number of the secondary user in a case of multiple primary users according to an embodiment of the present disclosure. In FIG. 11, 100 primary users are provided, and the number of secondary users is gradually increased from 100 to 1000. As shown in FIG. 11, without implementing the embodiment according to the present disclosure, a probability that the secondary user is interrupted increases dramatically with the increase in the number of the secondary user, and about 560 out of 1000 secondary users are interrupted. In the embodiment according to the present disclosure, the probability that the secondary user is interrupted is significantly reduced, and the number of secondary users which are interrupted out of 1000 is less than 100. It can be seen that, according to the embodiment of the present disclosure, the probability that the secondary user is interrupted can be significantly reduced. This is especially noticeable in the case of multiple primary users.

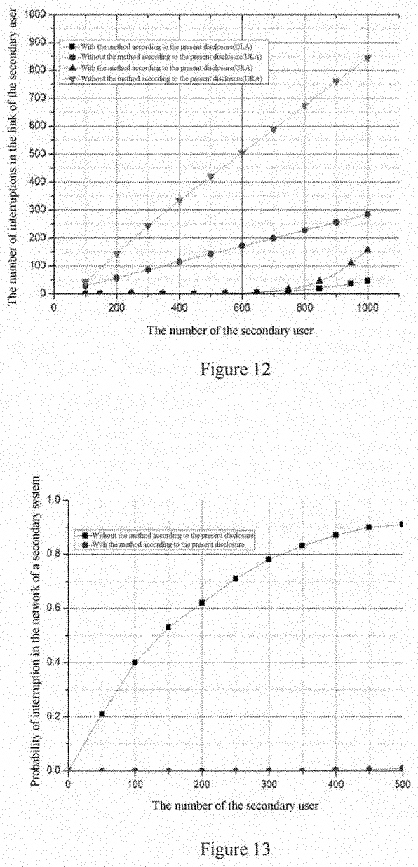

FIG. 12 is a simulation diagram showing that the number of interruptions in the link for the secondary user varies with the number of the secondary user in a case that different kinds of antennas are utilized by the primary user according to an embodiment of the present disclosure. In FIG. 12, 50 primary users are provided, and the number of secondary users is gradually increased from 100 to 1000. FIG. 12 shows the number of interruptions in the link for the secondary user varies with the number of secondary user in a case that the primary user is provided with the uniform linear array (ULA) and in a case that the primary user is provided with the uniform rectangular array (URA). As shown in FIG. 12, in the embodiment according to the present disclosure, the probability that the secondary user is interrupted is significantly reduced in both the case that the primary user is provided with the ULA and the case that the primary user is provided with the URA. For an scenario including 1000 secondary users, the probability that the secondary user is interrupted is reduced by 25% in a case that the primary user is provided with the ULA, and the probability that the secondary user is interrupted is reduced by 70% in a case the primary user is provided with the URA. It can be seen that the embodiments according to the present disclosure are universally applicable to the antenna of the primary user. That is, no matter what type of antenna the primary user is provided with, the probability that the secondary user is interrupted can be reduced. Further, the improvement in performance in the case of URA is better than that in the case of ULA.

FIG. 13 is a simulation diagram showing that the probability of interruption in a network of the secondary system varies with the number of the secondary user according to an embodiment of the present disclosure. In FIG. 13, 1 primary user is provided, and a scenario where drones cooperatively operate is considered. In this scenario, it is stipulated that all secondary users should not be interrupted. If a link for more than one secondary user is interrupted, it is considered that the network of this system is interrupted. As shown in FIG. 13, without implementing the embodiment according to the present disclosure, the probability of interruption in the network of the secondary system deteriorates rapidly as the number of secondary users increases. In embodiment according to the present disclosure, the probability of interruption in the network of the secondary system always maintains below 1%. It can be seen that, according to the embodiment of the present disclosure, the cooperative operation of secondary users is effectively supported in the case of a small number of primary users, which ensures the connection of the network of the secondary system.

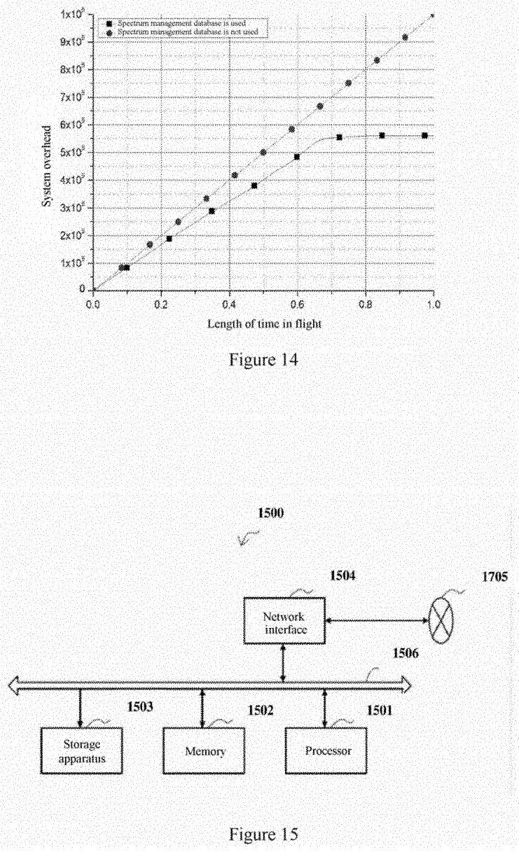

FIG. 14 is a simulation diagram showing that system overhead varies with a length of time in flight according to an embodiment of the present disclosure. The system overhead is divided into two parts, with one part being the cost of executing an algorithm, which is denoted by a, and the other part being the cost of searching and updating a spectrum management database, which is denoted by β. In a simulation, it is assumed that α=100β. After the scenario is switched 100,000 times (where the scenario being switched one time is defined as a secondary user entering/leaving the protection area), a simulation result of the system overhead is shown in FIG. 14, where the system overhead is expressed as a multiple of a. It can be seen that in a case that the spectrum management database is not used (that is, the interference suppression algorithm is performed each time a secondary user enters the buffer area without searching the spectrum management database for the historical configuration information), the system overhead grows linearly. In a case that the spectrum management database is used, the system overhead gradually becomes flat as time increases. Here, the reason why an inflection point occurs in a system overhead curve is that almost all scenarios each have been recorded as a historical scenario after a sufficient period of time, and a matched historical scenario is found when the secondary user enters or leaves the protection area. It can be seen that, according to the embodiment of the present disclosure, the system overhead can be successfully reduced by storing the historical scenario and historical configuration information.

### 5. Application Example

The technology of the present disclosure is applicable to various products.

For example, the electronic device 200 may be implemented as any type of server, such as a tower server, a rack server, and a blade server. The electronic device 200 may be a control module (such as an integrated circuitry module including a single die, and a card or blade inserted into a slot of a blade server) mounted on a server.

The user equipment may be implemented as a mobile terminal (such as a smartphone, a tablet personal computer (PC), a notebook PC, a portable game terminal, a portable/dongle type mobile router, and a digital camera), or a vehicle-mounted terminal (such as a car navigation device). The user equipment may also be implemented as a terminal that performs machine-to-machine (M2M) communication (that is also referred to as a machine type communication (MTC) terminal). In addition, the user equipment may further be a wireless communication module (such as an integrated circuitry module including a single die) mounted on each of the above user equipment.

<Application Example for a Server>

FIG. 15 is a block diagram showing an example of a server 1500 capable of implementing the electronic device 200 according to the present disclosure. The server 1500 includes a memory 1501, a memory 1502, a memory apparatus 1503, a network interface 1504 and a bus 1506.

The processor 1501 may be, for example, a central processing unit (CPU) or a digital signal processor (DSP), and controls a function of the server 1500. The memory 1502 includes a random access memory (RAM) and a read only memory (ROM), and stores data and a program that is executed by the processor 1501. The memory apparatus 1503 may include a memory medium, such as a semiconductor memory and a hard disk.

The network interface 1504 is a wired communication interface for connecting the server 1500 to a wired communication network 1505. The wired communication network 1505 may be a core network such as an evolved packet core network (EPC) or a packet data network (PDN) such as the Internet.

The processor 1501, the memory 1502, the storage apparatus 1503 and the network interface 1704 are connected to each other via the bus 1506. The bus 1506 may include two or more buses having different speeds (such as a high-speed bus and a low-speed bus).

In the server 1500 shown in FIG. 15, the protection area determination unit 210, the buffer area determination unit 220, and the interference suppression unit 230 shown in FIG. 2 may be implemented by the processor 1501, and the communication unit 240 shown in FIG. 2 may be implemented by network interface 1504. For example, the processor 1501 may determine the protection area, determine the buffer area, and perform the interference suppression by executing an instruction stored in the memory 1502 or the storage apparatus 1503.

<Application Example for Terminal Device>

(First Application Example)

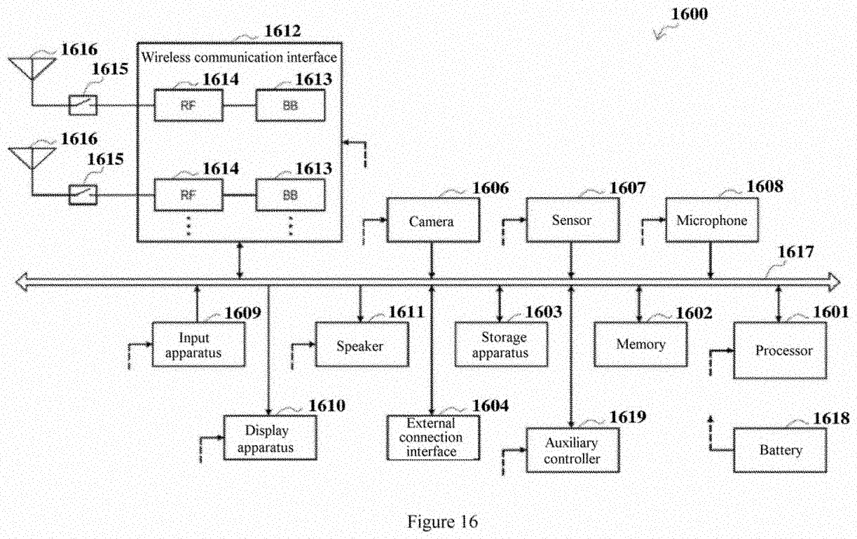

FIG. 16 is a block diagram showing an example of a schematic configuration of a smartphone 1600 to which the technology of the present disclosure may be applied. The smartphone 1600 includes a processor 1601, a memory 1602, a storage apparatus 1603, an external connection interface 1604, a camera 1606, a sensor 1607, a microphone 1608, an input apparatus 1609, a display apparatus 1610, a speaker 1611, a wireless communication interface 1612, one or more antenna switch 1615, one or more antenna 1616, a bus 1617, a battery 1618 and an auxiliary controller 1619.

The processor 1601 may be, for example, a CPU or a system on chip (SoC), and controls the functions of the application layer and another layer of the smartphone 1600. The memory 1602 includes a RAM and a ROM, and stores a program that is executed by the processor 1601, and data. The storage apparatus 1603 may include a storage medium such as a semiconductor memory and a hard disk. The external connection interface 1604 is an interface via which an external apparatus (such as a memory card and a universal serial bus (USB) apparatus) is connected to the smartphone 1600.

The camera 1606 includes an image sensor (such as a charge coupled device (CCD) and a complementary metal oxide semiconductor (CMOS)) and generates a captured image. The sensor 1607 may include a group of sensors, such as a measurement sensor, a gyroscope sensor, a geomagnetic sensor and an acceleration sensor. The microphone 1608 converts sounds that are inputted to the smart phone 1600 into audio signals. The input apparatus 1609 includes, for example, a touch sensor configured to detect touch onto a screen of the display apparatus 1610, a keypad, a keyboard, a button, or a switch, and receives an operation or information inputted from a user. The display apparatus 1610 includes a screen (such as a liquid crystal display (LCD) and an organic light-emitting diode (OLED) display), and displays an output image of the smartphone 1600. The speaker 1611 converts audio signals that are outputted from the smartphone 1600 to sounds.

The wireless communication interface 1612 supports any cellular communication scheme (such as LET and LTE-Advanced), and performs wireless communications. The wireless communication interface 1612 may generally include, for example, a BB processor 1613 and RF circuitry 1614. The BB processor 1613 may perform, for example, encoding/decoding, modulating/demodulating and multiplexing/de-multiplexing, and perform various types of signal processing for wireless communications. The RF circuitry 1614 may include a mixer, a filter and an amplifier for example, and transmits and receives a radio signal via the antenna 1616. The wireless communication interface 1612 may be a chip module on which the BB processor 1613 and the RF circuitry 1614 are integrated. As shown in FIG. 16, the wireless communication interface 1612 may include the multiple BB processors 1613 and the multiple RF circuitry 1614. Although FIG. 16 illustrates the example in which the wireless communication interface 1612 includes the multiple BB processors 1613 and the multiple RF circuitry 1614, the wireless communication interface 1612 may also include a single BB processor 1613 or single RF circuitry 1614.

Furthermore, in addition to the cellular communication scheme, the wireless communication interface 1612 may support another type of wireless communication scheme such as a short-distance wireless communication scheme, a near field communication scheme, and a wireless local area network (LAN) scheme. In this case, the wireless communication interface 1612 may include the BB processor 1613 and the RF circuitry 1614 for each wireless communication scheme.

Each of the antenna switches 1615 switches a connection destination of the antenna 1616 among multiple circuitry (such as circuitry for different wireless communication schemes) included in the wireless communication interface 1612.

Each of the antennas 1616 includes one antenna element or multiple antenna elements (such as multiple antenna elements included in the MIMO antenna), and is used for the wireless communication interface 1612 to transmit and receive a radio signal. The smartphone 1600 may include the multiple antennas 1616, as illustrated in FIG. 16. Although FIG. 16 illustrates the example in which the smartphone 1600 includes the multiple antennas 1616, the smart phone 1600 may also include a single antenna 1616.

Furthermore, the smartphone 1600 may include the antenna 1616 for each wireless communication scheme. In this case, the antenna switch 1615 may be removed from the configuration of the smartphone 1600.

The processor 1601, the memory 1602, the storage apparatus 1603, the external connection interface 1604, the camera 1606, the sensor 1607, the microphone 1608, the input apparatus 1609, the display apparatus 1610, the speaker 1611, the wireless communication interface 1612 and the auxiliary controller 1619 are connected to each other via bus 1617. The battery 1618 supplies power to blocks in the smartphone 1600 shown in FIG. 16 via a feeder line which is indicated partially as a dashed line in FIG. 16. The auxiliary controller 1619 operates a minimum necessary function of the smartphone 1600 in a sleeping mode, for example.

(Second Application Example)

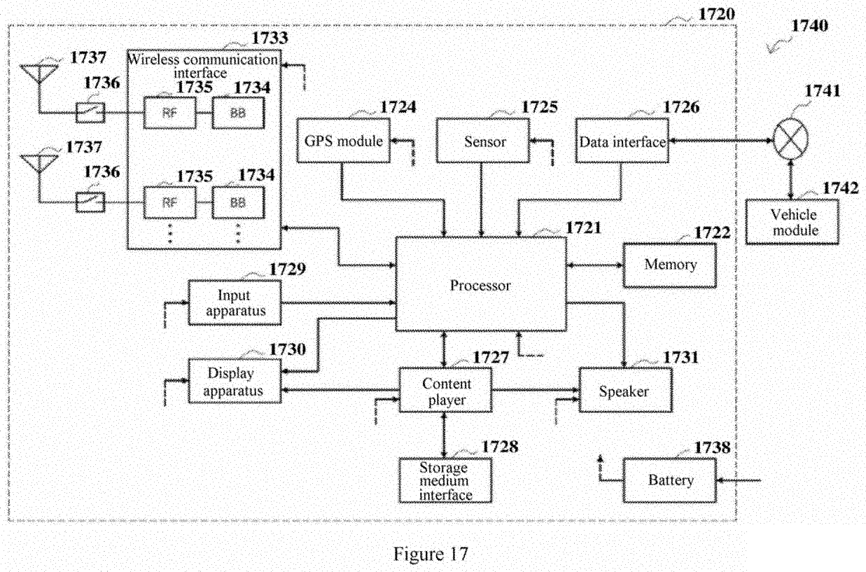

FIG. 17 is a block diagram showing an example of a schematic configuration of a car navigation device 1720 to which the technology according to the present disclosure may be applied. The car navigation device 1720 includes a processor 1721, a memory 1722, a global positioning system (GPS) module 1724, a sensor 1725, a data interface 1726, a content player 1727, a storage medium interface 1728, an input apparatus 1729, a display apparatus 1730, a speaker 1731, a wireless communication interface 1733, one or more antenna switches 1736, one or more antennas 1737 and a battery 1738.

The processor 1721 may be, for example, a CPU or an SoC, and controls a navigation function and additional function of the car navigation device 1720. The memory 1722 includes a RAM and a ROM, and stores a program executed by the processor 1721, and data.

The GPS module 1724 measures a position (such as latitude, longitude and altitude) of the car navigation device 1720 based on a GPS signal received from a GPS satellite. The sensor 1725 may include a group of sensors such as a gyroscope sensor, a geomagnetic sensor, and an air pressure sensor. The data interface 1726 is connected to, for example, a vehicle-mounted network 1741 via a terminal not shown, and acquires data generated by the vehicle (such as vehicle speed data).

The content player 1727 reproduces content stored in a storage medium (such as a CD and a DVD) inserted into the storage medium interface 1728. The input apparatus 1729 includes, for example, a touch sensor configured to detect touch on a screen of the display apparatus 1730, a button, or a switch, and receives an operation or information inputted from a user. The display apparatus 1730 includes a screen such as an LCD or an OLED display, and displays an image of the navigation function or content that is reproduced. The speaker 1731 outputs sound of the navigation function or the content that is reproduced.

The wireless communication interface 1733 supports any cellular communication scheme (such as LET and LTE-Advanced), and performs wireless communications. The wireless communication interface 1733 may generally include, for example, a BB processor 1734 and RF circuitry 1735. The BB processor 1734 may perform, for example, encoding/decoding, modulating/demodulating and multiplexing/de-multiplexing, and perform various types of signal processing for wireless communications. The RF circuitry 1735 may include a mixer, a filter and an amplifier for example, and transmits and receives a radio signal via the antenna 1737. The wireless communication interface 1733 may be a chip module on which the BB processor 1734 and the RF circuitry 1735 are integrated. As shown in FIG. 17, the wireless communication interface 1733 may include multiple BB processors 1734 and multiple RF circuitry 1735. Although FIG. 17 illustrates the example in which the wireless communication interface 1733 includes the multiple BB processors 1734 and the multiple RF circuitry 1735, the wireless communication interface 1733 may also include a single BB processor 1734 or single RF circuitry 1735.

Furthermore, in addition to the cellular communication scheme, the wireless communication interface 1733 may support another type of radio communication scheme such as a short-distance wireless communication scheme, a near field communication scheme, and a wireless LAN scheme. In this case, the wireless communication interface 1733 may include the BB processor 1734 and the RF circuitry 1735 for each wireless communication scheme.

Each of the antenna switches 1736 switches a connection destination of the antenna 1737 among multiple circuitry (such as circuitry for different wireless communication schemes) included in the wireless communication interface 1733.

Each of the antennas 1737 includes one antenna element or multiple antenna elements (such as multiple antenna elements included in the MIMO antenna), and is used for the wireless communication interface 1733 to transmit and receive a radio signal. The car navigation device 1720 may include multiple antennas 1737, as shown in FIG. 17. Although FIG. 17 shows the example in which the car navigation device 1720 includes the multiple antennas 1737, the car navigation device 1720 may also include a single antenna 1737.

In addition, the car navigation device 1720 may include an antenna 2137 for each wireless communication scheme. In this case, the antenna switch 1736 may be removed from the configuration of the car navigation device 1720.

The battery 1738 supplies power to the blocks of the car navigation device 1720 shown in FIG. 17 via a feeder line, which is partially shown with a dash line in FIG. 17. The battery 1738 accumulates power from the vehicle.

The technology of the present disclosure may also be implemented as a vehicle-mounted system (or a vehicle) 1740 including one or more blocks of the car navigation device 1720, the vehicle-mounted network 1741 and a vehicle module 1742. The vehicle module 1742 generates vehicle data (such as vehicle speed, engine speed, and trouble information), and outputs the generated data to the vehicle-mounted network 1741.

Preferred embodiments of the present disclosure have been described above with reference to the drawings. However, the present disclosure is not limited to the above examples. Those skilled in the art may make various changes and modifications within the scope of the appended claims, and it should be understood that such changes and modifications naturally fall within the technical scope of the present disclosure.

For example, a unit shown by a dotted line box in the functional block diagram in the drawings indicates that the functional unit is optional in the corresponding device, and the optional functional units may be combined appropriately to achieve desired functions.

For example, multiple functions implemented by one unit in the above embodiments may be implemented by separate apparatus. Alternatively, multiple functions implemented by respective units in the above embodiments may be implemented by separate apparatuses. In addition, one of the above functions may be implemented by multiple units. Such configurations are naturally included in the technical scope of the present disclosure.

In the specification, steps described in the flowchart include not only the processes performed chronologically as the described sequence, but also the processes performed in parallel or individually rather than chronologically. Furthermore, the steps performed chronologically may be performed in another sequence appropriately.

Embodiments of the present disclosure are described above in detail in conjunction with the drawings. However, it should be understood that the embodiments described above are intended to illustrate the present disclosure rather than limit the present disclosure. Those skilled in the art may make various modifications and alternations to the above embodiments without departing from the spirit and scope of the present disclosure. Therefore, the scope of the present disclosure is defined by the appended claims and equivalents thereof.

1. An electronic device, comprising a processing circuitry configured to:
determine, for a primary user and at least one secondary user, a primary user protection area surrounding the primary user, wherein the primary user protection area represents an area where the at least one secondary user causes interference to the primary user;
determine a buffer area surrounding the primary user protection area; and
monitor a position of the at least one secondary user, and adjust a configuration of the at least one secondary user and/or a configuration of the primary user when the at least one secondary user enters the buffer area, to suppress the interference caused by the at least one secondary user to the primary user.

2. The electronic device according to claim 1, wherein the processing circuitry is further configured to:
determine the primary user protection area based on an antenna configuration of the primary user, an antenna configuration of the at least one secondary user and a threshold of the interference that is tolerable for the primary user.

3. The electronic device according to claim 2, wherein the processing circuitry is further configured to:
determine a maximum transmission power of the at least one secondary user allowed at each position around the primary user based on the antenna configuration of the primary user, the antenna configuration of the at least one secondary user and the threshold of the interference that is tolerable for the primary user; and
determine the primary user protection area based on a transmission power of the at least one secondary user and the maximum transmission power of the secondary user allowed at each position around the primary user.

4. The electronic device according to claim 1, wherein the primary user protection area and the buffer area are both two-dimensional areas, or the primary user protection area and the buffer area are both three-dimensional areas.

5. The electronic device according to claim 1, wherein the processing circuitry is further configured to:
determine, as the buffer area, an area surrounding the primary user protection area, having the same shape as the primary user protection area and surrounded by a boundary at a predetermined distance from a boundary of the primary user protection area.

6. The electronic device according to claim 5, wherein the processing circuitry is further configured to determine the predetermined distance based on at least one of the following parameters: a speed of the at least one secondary user, a speed at which the at least one secondary user processes data, a speed at which the primary user processes data, and a speed at which the electronic device processes data.

7. The electronic device according to claim 1, wherein the processing circuitry is further configured to:
determine, when the at least one secondary user enters the buffer area, whether historical configuration information corresponding to a scenario including the primary user and the at least one secondary user is stored; and
determine an adjusted configuration of the at least one secondary user and/or an adjusted configuration of the primary user based on the historical configuration information if there is historical configuration information corresponding to the scenario.

8. The electronic device according to claim 7, wherein the processing circuitry is further configured to:
determine the adjusted configuration of the at least one secondary user and/or the adjusted configuration of the primary user based on a threshold of the interference that is tolerable for the primary user if there is no historical configuration information corresponding to the scenario.

9. The electronic device according to claim 8, wherein
the configuration of the at least one secondary user comprises a transmission power of the at least one secondary user and/or an operating frequency of the at least one secondary user, and
the configuration of the primary user comprises an antenna configuration of the primary user.

10. The electronic device according to claim 9, wherein the processing circuitry is further configured to:
adjust the transmission power of the at least one secondary user if there is no historical configuration information corresponding to the scenario.

11. The electronic device according to claim 10, wherein the transmission power of the at least one secondary user is adjusted by reducing the transmission power of the at least one secondary user.

12. The electronic device according to claim 10, wherein the processing circuitry is further configured to:
determine whether the interference suffered by the primary user is tolerable after the transmission power of the at least one secondary user is adjusted; and
adjust the antenna configuration of the primary user in a case that the interference suffered by the primary user is intolerable.

13. The electronic device according to claim 12, wherein the antenna configuration of the primary user is adjusted by increasing the number of antenna elements of the primary user, reducing the number of antenna elements of the primary user, and/or adjusting a weight of an antenna element of the primary user.

14. The electronic device according to claim 12, wherein the processing circuitry is further configured to:
determine whether the interference suffered by the primary user is tolerable after the antenna configuration of the primary user is adjusted; and
adjust the operating frequency of the at least one secondary user in a case that the interference suffered by the primary user is intolerable.

15. The electronic device according to claim 8, wherein the processing circuitry is further configured to:
store the adjusted configuration of the at least one secondary user and/or the adjusted configuration of the primary user as historical configuration information corresponding to the scenario including the primary user and the at least one secondary user.

16. The electronic device according to claim 1, wherein the electronic device is a coexistence manager CxM.

17. A method for wireless communications, wherein the method is performed by an electronic device and comprises:
determining, for a primary user and at least one secondary user, a primary user protection area surrounding the primary user, wherein the primary user protection area represents an area where the at least one secondary user causes interference to the primary user;
determining a buffer area surrounding the primary user protection area; and
monitoring a position of the at least one secondary user, and adjusting a configuration of the at least one secondary user and/or a configuration of the primary user when the at least one secondary user enters the buffer area, to suppress the interference caused by the at least one secondary user to the primary user.

18. The method for wireless communications according to claim 17, wherein the determining a protection area comprises:
determining the primary user protection area based on an antenna configuration of the primary user, an antenna configuration of the at least one secondary user and a threshold of the interference that is tolerable for the primary user.

19. The method for wireless communications according to claim 18, wherein the determining a protection area comprises:
determining a maximum transmission power of the at least one secondary user allowed at each position around the primary user based on the antenna configuration of the primary user, the antenna configuration of the at least one secondary user and the threshold of the interference that is tolerable for the primary user; and
determining the primary user protection area based on a transmission power of the at least one secondary user and the maximum transmission power of the at least one secondary user allowed at each position around the primary user.

20.-32. (canceled)

33. A non-transitory computer readable storage medium comprising executable computer instructions that, when executed by a computer, cause the computer to perform the method for wireless communications according to claim 17.
